(19) United States
(12) Patent Application Publication
(10) Pub. No.: US 2024/0160690 A1
(43) Pub. Date: May 16, 2024

(54) INFORMATION PROCESSING APPARATUS, INFORMATION PROCESSING METHOD, AND STORAGE MEDIUM

(71) Applicant: NEC Corportion, Minato-ku, Tokyo (JP)

(72) Inventors: Yoshitaka ITO, Tokyo (JP); Hitoshi YAMAMOTO, Tokyo (JP); Yoshinori KODA, Tokyo (JP); Kouji OOSUGI, Tokyo (JP)

(73) Assignee: NEC Corportion, Minato-ku, Tokyo (JP)

(21) Appl. No.: 18/281,828

(22) PCT Filed: Mar. 18, 2021
(86) PCT No.: PCT/JP2021/011243

§ 371 Date: Sep. 13, 2023

(51) Int. Cl. G06F 17/16

(52) U.S. Cl. CPC G06F 17/16

(57) ABSTRACT

There is provided an information processing apparatus including a calculation means for calculating a projection matrix used for dimensionality reduction of a plurality of data based on an objective function. The objective function includes a first function including a first term indicating interclass dispersion of the plurality of data between a first class and a second class included in a plurality of classes and a second function including a second term indicating intraclass dispersion of the plurality of data in at least one of the first class and the second class. The calculation means performs optimization of the objective function under a constraint in which the first class and the second class are selected so that a combination of the first class and the second class includes a specific class.

### TECHNICAL FIELD

This disclosure relates to an information processing apparatus, an information processing method, and a storage medium.

### BACKGROUND ART

In processing such as machine learning that deals with high-dimensional data, dimensionality reduction may be performed. In such applications, it is desirable that the data be appropriately separated depending on classes after the dimensionality reduction. PTL 1 discloses an example of a method of generating a projection matrix used for dimensionality reduction.

### CITATION LIST

### Patent Literature

PTL 1: Japanese Patent Laid-Open No. 2010-39778

### SUMMARY

### Technical Problem

In a dimensionality reduction method as described in PTL 1, there may be a need for a method that can better separate classes.

It is an object of this disclosure to provide an information processing apparatus, an information processing method, and a storage medium which realize dimensionality reduction in which classes can be better separated.

### Solution to Problem

According to an example aspect of this disclosure, there is provided an information processing apparatus including an acquisition means for acquiring a plurality of data each classified into one of a plurality of classes, and a calculation means for calculating a projection matrix used for dimensionality reduction of the plurality of data based on an objective function including a statistic of the plurality of data. The objective function includes a first function including a first term indicating interclass dispersion of the plurality of data between a first class and a second class included in the plurality of classes and a second function including a second term indicating intraclass dispersion of the plurality of data in at least one of the first class and the second class. The calculation means performs calculation of the projection matrix by optimizing the objective function under a constraint in which the first class and the second class are selected so that a combination of the first class and the second class includes a specific class that is one of the plurality of classes.

According to another example aspect of this disclosure, there is provided an information processing method performed by a computer, including acquiring a plurality of data each classified into one of a plurality of classes, and calculating a projection matrix used for dimensionality reduction of the plurality of data based on an objective function including a statistic of the plurality of data. The objective function includes a first function including a first term indicating interclass dispersion of the plurality of data between a first class and a second class included in the plurality of classes and a second function including a second term indicating intraclass dispersion of the plurality of data in at least one of the first class and the second class. The calculating the projection matrix includes performing calculation of the projection matrix by optimizing the objective function under a constraint in which the first class and the second class are selected so that a combination of the first class and the second class includes a specific class that is one of the plurality of classes.

According to another example aspect of this disclosure, there is provided a storage medium storing a program that causes a computer to perform an information processing method, the information processing method including acquiring a plurality of data each classified into one of a plurality of classes, and calculating a projection matrix used for dimensionality reduction of the plurality of data based on an objective function including a statistic of the plurality of data. The objective function includes a first function including a first term indicating interclass dispersion of the plurality of data between a first class and a second class included in the plurality of classes and a second function including a second term indicating intraclass dispersion of the plurality of data in at least one of the first class and the second class. The calculating the projection matrix includes performing calculation of the projection matrix by optimizing the objective function under a constraint in which the first class and the second class are selected so that a combination of the first class and the second class includes a specific class that is one of the plurality of classes.

### BRIEF DESCRIPTION OF DRAWINGS

FIG. 1 is a block diagram showing a hardware configuration of an information processing apparatus according to a first example embodiment.

FIG. 2 is a functional block diagram of the information processing apparatus according to the first example embodiment.

FIG. 3 is a flowchart showing an outline of training processing performed by the information processing apparatus according to the first example embodiment.

FIG. 4 is a flowchart showing an outline of determination processing performed by the information processing apparatus according to the first example embodiment.

FIG. 5 is a diagram schematically showing a relationship between variances of a plurality of classes and directions of projection axes.

FIG. 6 is a flowchart showing an outline of projection matrix calculation processing performed by the information processing apparatus according to the second example embodiment.

FIG. 7A is a diagram schematically showing dispersion of a plurality of classes.

FIG. 7B is a diagram showing a distribution of training data when a class CL1 is set as a specific class.

FIG. 7C is a diagram showing a distribution of training data when a class CL3 is set as a specific class.

FIG. 8 is a block diagram showing a configuration of an information processing system according to a fifth example embodiment.

FIG. 9 is a functional block diagram showing a configuration of the information processing system according to the fifth example embodiment.

FIG. 10 is a schematic diagram showing an operation of the information processing system according to the fifth example embodiment.

FIG. 11 is a schematic diagram showing an overall configuration of an information processing system according to a sixth example embodiment.

FIG. 12 is a block diagram showing a hardware configuration example of an earphone control device according to the sixth example embodiment.

FIG. 13 is a functional block diagram of an earphone and an information processing apparatus according to the sixth example embodiment.

FIG. 14 is a flowchart showing an outline of biometric matching processing performed by the information processing apparatus according to the sixth example embodiment.

FIG. 15 is a functional block diagram of an information processing apparatus according to a seventh example embodiment.

### DESCRIPTION OF EMBODIMENTS

Example embodiments of this disclosure will now be described with reference to the accompanying drawings. In the drawings, similar or corresponding elements are denoted by the same reference numerals, and description thereof may be omitted or simplified.

### First Example Embodiment

An information processing apparatus according to this example embodiment calculates a projection matrix used for dimensionality reduction of input data. In addition, the information processing apparatus of this example embodiment may have a determination function for determining person identification or the like on data obtained by performing feature selection on input data using a projection matrix. This data may be, for example, feature amount data extracted from biometric information. In this case, the information processing apparatus may be a biometric matching apparatus that confirms the identity of a person based on the biometric information. Hereinafter, the information processing apparatus of this example embodiment is assumed to be a biometric matching apparatus including both a training function for calculating a projection matrix and a determination function based on the projection matrix, but this example embodiment is not limited thereto.

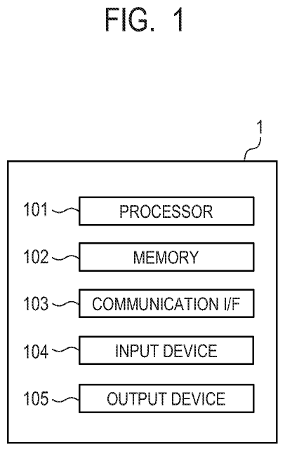

FIG. 1 is a block diagram showing a hardware configuration example of an information processing apparatus 1. The information processing apparatus 1 of this example embodiment may be a computer such as a personal computer (PC), a processing server, a smartphone, or a microcomputer. The information processing apparatus 1 includes a processor 101, a memory 102, a communication interface (I/F) 103, an input device 104, and an output device 105. The units of the information processing apparatus 1 are connected to each other via a bus, wiring, a driving device, and the like (not shown).

The processor 101 is, for example, a processing device including one or more arithmetic processing circuits such as a central processing unit (CPU), a graphics processing unit (GPU), a field-programmable gate array (FPGA), an application specific integrated circuit (ASIC), and a tensor processing unit (TPU). The processor 101 has a function of performing a predetermined operation in accordance with a program stored in the memory 102 or the like and controlling each unit of the information processing apparatus 1.

The memory 102 may include a volatile storage medium that provides a temporary memory area necessary for the operation of the processor 101, and a non-volatile storage medium that non-temporarily stores information such as data to be processed and an operation program of the information processing apparatus 1. Examples of the volatile storage medium include a random access memory (RAM). Examples of the non-volatile storage medium include a read only memory (ROM), a hard disk drive (HDD), a solid state drive (SSD), and a flash memory.

The communication I/F 103 is a communication interface based on standards such as Ethernet (registered trademark), Wi-Fi (registered trademark), and Bluetooth (registered trademark). The communication I/F 103 is a module for communicating with other devices such as a data server and a sensor device.

The input device 104 is a keyboard, a pointing device, a button, or the like, and is used by a user to operate the information processing apparatus 1. Examples of the pointing device include a mouse, a trackball, a touch panel, and a pen tablet. The input device 104 may include a sensor device such as a camera, a microphone, and the like. These sensor devices may be used to obtain biometric information.

The output device 105 is a device that presents information to a user such as a display device and a speaker. The input device 104 and the output device 105 may be integrally formed as a touch panel.

In FIG. 1, the information processing apparatus 1 is configured by one apparatus, but the configuration of the information processing apparatus 1 is not limited thereto. For example, the information processing apparatus 1 may be a system including a plurality of apparatuses. Further, the information processing apparatus 1 may be added with other devices or may not be provided with some of the devices. Some devices may be replaced with other devices having similar functions. Further, some functions of this example embodiment may be provided by other apparatuses via a network, or the functions of this example embodiment may be distributed among a plurality of apparatuses. For example, the memory 102 may include cloud storage, which is a storage device provided in another apparatus. Thus, the hardware configuration of the information processing apparatus 1 can be changed as appropriate.

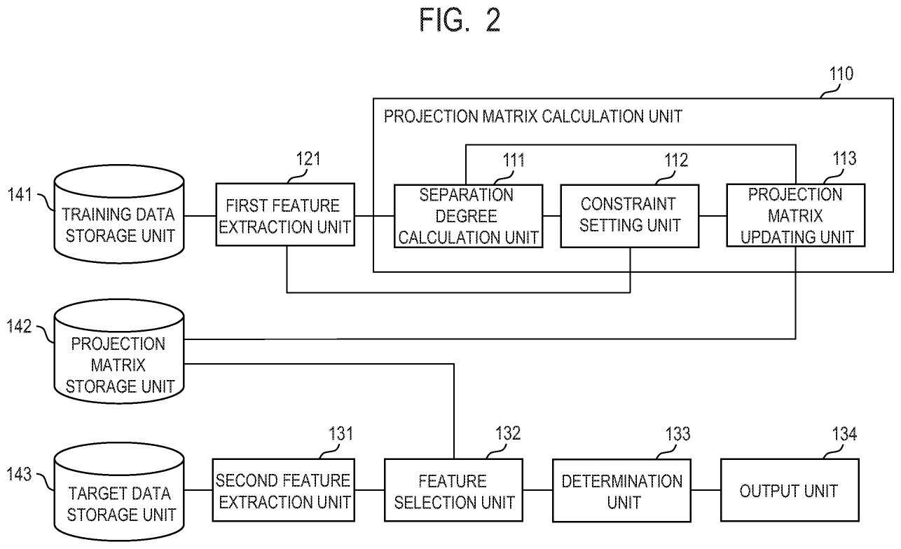

FIG. 2 is a functional block diagram of the information processing apparatus 1 according to this example embodiment. The information processing apparatus 1 includes a projection matrix calculation unit 110, a first feature extraction unit 121, a second feature extraction unit 131, a feature selection unit 132, a determination unit 133, an output unit 134, a training data storage unit 141, a projection matrix storage unit 142, and a target data storage unit 143. The projection matrix calculation unit 110 includes a separation degree calculation unit 111, a constraint setting unit 112, and a projection matrix updating unit 113.

The processor 101 performs predetermined arithmetic processing by executing a program stored in the memory 102. The processor 101 controls the memory 102, the communication I/F 103, the input device 104, and the output device 105 based on the program. Thus, the processor 101 realizes functions of the projection matrix calculation unit 110, the first feature extraction unit 121, the second feature extraction unit 131, the feature selection unit 132, the determination unit 133, and the output unit 134. The memory 102 realizes functions of the training data storage unit 141, the projection matrix storage unit 142, and the target data storage unit 143. The first feature extraction unit 121 and the projection matrix calculation unit 110 may be referred to as an acquisition means and a calculation means, respectively.

A part of the functional blocks shown in FIG. 2 may be provided in an apparatus outside the information processing apparatus 1, or may be realized by cooperation of a plurality of apparatuses. For example, the information processing apparatus 1 may be divided into a training apparatus that performs training using training data and a determination apparatus that performs determination on target data. In this case, the training apparatus may include the projection matrix calculation unit 110, the first feature extraction unit 121, and the training data storage unit 141. The determination apparatus may include the second feature extraction unit 131, the feature selection unit 132, the determination unit 133, the output unit 134, and the target data storage unit 143.

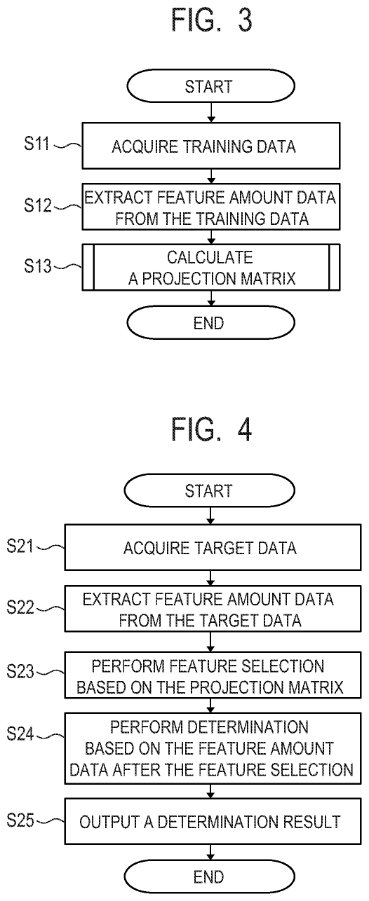

FIG. 3 is a flowchart showing an outline of training processing performed by the information processing apparatus 1 according to this example embodiment. The training processing of this example embodiment is started when, for example, an instruction of the training processing using the training data is issued to the information processing apparatus 1 by a user operation or the like. However, the timing at which the training processing of this example embodiment is performed is not particularly limited, and may be at the time when the information processing apparatus 1 acquires the training data, or may be repeatedly performed at predetermined time intervals. In this example embodiment, it is assumed that training data each classified into one of a plurality of classes are stored in the training data storage unit 141 in advance, but the training data may be acquired from another apparatus such as a data server at the time of executing the training processing.

In step S11, the first feature extraction unit 121 acquires training data from the training data storage unit 141. To the training data, information indicating which of a plurality of classes is classified is associated in advance by a user or the like. For example, in the case where the training data are sensor data acquired from a living body, an object, or the like, the plurality of classes may be identification numbers or the like that identify a person, an object, or the like from which the training data have been acquired.

In step S12, the first feature extraction unit 121 extracts feature amount data from the training data. In step S13, the projection matrix calculation unit 110 calculates a projection matrix. The calculated projection matrix is stored in the projection matrix storage unit 142. Generally, feature amount data are multidimensional data, and in order to appropriately perform determination based on the feature amount data, dimensionality reduction may be required. The projection matrix calculation unit 110 performs training for determining a projection matrix for performing dimensionality reduction based on the training data. The details of the processing in the step S13 will be described later.

Note that feature amount data extracted from the training data may be stored in the training data storage unit 141 in advance, and in this case, the processing of the step S12 may be omitted.

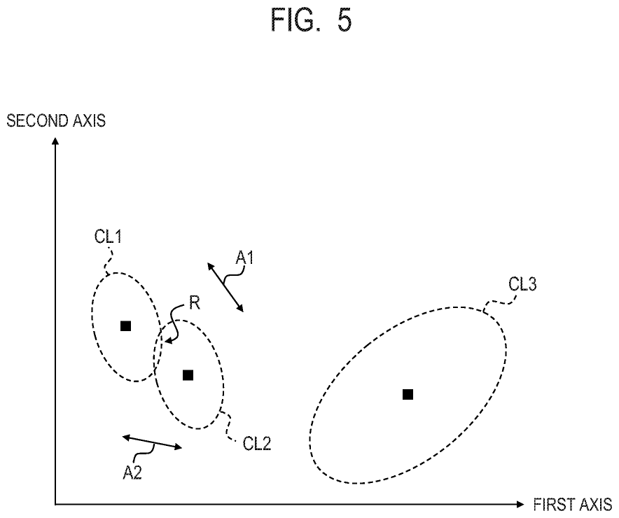

FIG. 4 is a flowchart showing an outline of determination processing performed by the information processing apparatus 1 according to this example embodiment. The determination processing of this example embodiment is started when, for example, an instruction of the determination processing using the target data is issued to the information processing apparatus 1 by a user operation or the like. However, the timing at which the determination processing of this example embodiment is performed is not particularly limited, and may be at the time when the information processing apparatus 1 acquires the target data, or may be repeatedly performed at predetermined time intervals. In this example embodiment, it is assumed that the projection matrix is stored in the projection matrix storage unit 142, and the target data is stored in the target data storage unit 143 in advance, but the target data may be acquired from another apparatus such as a data server at the time of performing the training processing.

In step S21, the second feature extraction unit 131 acquires the target data from the target data storage unit 143. The target data are unknown data to be determined in this determination processing.

In step S22, the second feature extraction unit 131 extracts feature amount data from the target data. In step S23, the feature selection unit 132 performs feature selection based on the projection matrix for the target data. Specifically, this processing reduces the dimension of the target data by applying a projection matrix to the target data. More conceptually, the feature selection unit 132 performs a processing of reducing the number of features by selecting features that reflect the property of the target data well.

In step S24, the determination unit 133 performs determination based on the feature amount data after the feature selection. For example, when the determination by the determination unit 133 is class classification, this determination is a processing of determining a class to which each input feature amount data belongs. Further, for example, when the determination by the determination unit 133 is person identification in biometric matching, the determination is a processing of determining whether or not a person from whom the target data is acquired is the same person as a registered person.

In step S25, the output unit 134 outputs a determination result by the determination unit 133. The output destination may be the memory 102 in the information processing apparatus 1, or may be another apparatus.

Next, specific contents of the projection matrix calculation processing in the step S13 of FIG. 3 will be described. Prior to the description of the projection matrix calculation processing of this example embodiment, the theoretical background of the projection matrix calculation processing of this example embodiment will be described with reference to linear discriminant analysis (LDA) and worst-case linear discriminant analysis (WLDA) related to the processing of this example embodiment. Subsequently, worst-ratio linear discriminant analysis (WRLDA) and personalized worst-ratio linear discriminant analysis (PWRLDA), which are examples of the projection matrix calculation processing of this example embodiment, will be described.

Let d be the number of dimensions of training data, n be the number of training data, xi be a d-dimensional vector indicating the i-th training data, C be the number of classes, and r be the number of dimensions after dimensionality reduction. A projection matrix W is represented by a real matrix of d rows and r columns as shown in the following expression (1). By applying the projection matrix W to the training data xi, the number of dimensions can be reduced from d dimension to r dimension.

[Math. 1]

W∈ [symbol] ^{d×r} (1)

Several methods for calculating the projection matrix W have been proposed to achieve appropriate dimensionality reduction. As an example of the method, first, an outline of the LDA will be described.

The optimization problem of determining the projection matrix W by using LDA is expressed by the following expression (2).

$$\begin{matrix}[ Math . 2 ] & \\ {arg max}_{W} tr \{ {( {W}^{T} {S}_{w} W )}^{- 1} {W}^{T} {S}_{b} W \} & ( 2 )\end{matrix}$$

Here, the matrices S_{b} and S_{w} are defined by the following expressions (3) to (6). Argmax (⋅) represents an argument giving a maximum value of a function in the parentheses, tr (⋅) represents a trace of a square matrix, and W^{T} represents a transposed matrix of W.

$$\begin{matrix}[ Math . 3 ] & \\ {S}_{b} = {\sum }_{k = 1}^{C} \frac{{n}_{k}}{n} ( {\overline{m}}_{k} - \overline{m} ) {( {\overline{m}}_{k} - \overline{m} )}^{T} & ( 3 )\end{matrix}$$

$$\begin{matrix}[ Math . 4 ] & \\ {S}_{w} = {\sum }_{k = 1}^{C} {\sum }_{{x}_{i} ∈ {Π}_{k}}^{} \frac{1}{n} ( {x}_{i} - {\overline{m}}_{k} ) {( {x}_{i} - {\overline{m}}_{k} )}^{T} & ( 4 )\end{matrix}$$

$$\begin{matrix}[ Math . 5 ] & \\ {\overline{m}}_{k} = \frac{1}{{n}_{k}} {\sum }_{{x}_{i} ∈ {Π}_{k}}^{} {x}_{i} & ( 5 )\end{matrix}$$

$$\begin{matrix}[ Math . 6 ] & \\ \overline{m} = \frac{1}{n} {\sum }_{i = 1}^{n} {x}_{i} & ( 6 )\end{matrix}$$

The expression (5) represents an intraclass average of xᵢ in the k-th class Πₖ, and the expression (6) is a sample average of all training data. Therefore, the matrix S_{b} is a matrix indicating an average of interclass variances, and the matrix S_{w} is a matrix indicating an average of intraclass variances. That is, in the LDA, roughly, the projection matrix W is determined so as to maximize a ratio of a term indicating an average of interclass dispersion of the training data by a term indicating an average of intraclass dispersion of the training data. This method focuses only on the average in the optimization, thus neglecting the risk of confusion among critical classes such as data being distributed such that only a part of different classes overlaps.

Therefore, WLDA focusing on the worst case has been proposed. An outline of WLDA will be described below. The optimization problem of determining the projection matrix W by using WLDA is expressed by the following expressions (7) and (8).

$$\begin{matrix}[ Math . 7 ] & \\ {arg max}_{W} \frac{{min}_{i , j} \{ tr ( {W}^{T} {S}_{ij} W ) \}}{{max}_{i} \{ tr ( {W}^{T} {S}_{i} W ) \}} & ( 7 )\end{matrix}$$

$$\begin{matrix}[ Math . 8 ] & \\ s . t . {W}^{T} W = {I}_{r} & ( 8 )\end{matrix}$$

The matrix I^{r} represents an identity matrix of r rows and r columns. Further, s. t. (subject to) in the expression (8) indicates a constraint. Here, the matrices Sᵢⱼ and Sₖ are defined by the following expressions (9) and (10).

$$\begin{matrix}[ Math . 9 ] & \\ {S}_{ij} = ( {\overline{m}}_{i} - {\overline{m}}_{j} ) ( {\overline{m}}_{i} - {\overline{m}}_{j} ) & ( 9 )\end{matrix}$$

$$\begin{matrix}[ Math . 10 ] & \\ {S}_{k} = \frac{1}{{n}_{k}} {\sum }_{{x}_{i} ∈ {Π}_{k}} ( {x}_{i} - {\overline{m}}_{k} ) {( {x}_{i} - {\overline{m}}_{k} )}^{T} & ( 10 )\end{matrix}$$

From these definitions, the matrix Sᵢⱼ is a matrix indicating interclass variance between the i-th class and the j-th class, and the matrix Sₖ is a matrix indicating intraclass variance of the k-th class. Expression (8) is a constraint referred to as an orthonormal constraint. The orthonormal constraint has a function of limiting the scale of each column of the projection matrix W and eliminating redundancy of the feature representation after the dimensionality reduction.

However, since the optimization problem (ideal WLDA) of the expressions (7) and (8) is a non-convex problem, it is not easy to solve the problem for W. Therefore, a constraint relaxation of the optimization problem of the expressions (7) and (8) is performed as follows.

First, a positive semidefinite matrix E of d rows and d columns corresponding to expression (11) is defined.

[Math. 11]

Σ=WW^{T} (11)

Next, a set indicating a solution space before the constraint relaxation is defined by the following expression (12). From the expression (11), Σ clearly belongs to this solution space.

[Math. 12]

[symbol]

_{w}={M_{w}|M_{w}=WW^{T}, W^{T}W=Iᵣ, W∈ [symbol] ^{d×r}}tm (12)

A convex hull of the set of the expression (12) is given by the following expression (13). The expression (13) is a set indicating a solution space after the constraint relaxation. In the expression (13), O_{d} represents a zero matrix of d rows and d columns, and I_{d} represents an identity matrix of d rows and d columns.

[Math. 13]

[symbol]

ₑ={Mₑ|tr(Mₑ)=r, O_{d} [symbol] Mₑ [symbol] I_{d}} (13)

Expression (14) indicates that the matrix (Mₑ-O_{d}) is positive semidefinite and the matrix (I_{d}-Mₑ) is positive semidefinite. The expression (14) included in the expression (13) is referred to as a positive semidefinite constraint.

[Math. 14]

O_{d} [symbol] Mₑ [symbol] I_{d} (14)

By using the expressions (11) and (13), the optimization problems of the expressions (7) and (8) can be relaxed as shown in the following expressions (15) and (16). In this deformation of expressions, the property that the trace of the matrix product is invariant with respect to the ordinal transformation of the matrix product in the case where the matrix sizes are appropriate is used.

$$\begin{matrix}[ Math . 15 ] & \\ {arg max}_{Σ} \frac{{min}_{i , j} \{ tr ( {S}_{ij} Σ ) \}}{{max}_{i} \{ tr ( {S}_{i} Σ ) \}} & ( 15 )\end{matrix}$$

$$\begin{matrix}[ Math . 16 ] & \\ s . t . Σ ∈ {ℳ}_{e} & ( 16 )\end{matrix}$$

The optimization problem (relaxed WLDA) of the expressions (15) and (16) can be optimized for Σ using the framework of the semidefinite programming problem.

The matrix Sᵢⱼ included in the objective function of WLDA is a matrix indicating the interclass variance, and the matrix Sᵢ is a matrix indicating the intraclass variance. Accordingly, in the WLDA, roughly, the projection matrix W is determined so as to maximize a ratio of a term indicating a minimum value of interclass dispersion of the training data to a term indicating a maximum value of intraclass dispersion of the training data. In this method, the worst-case combination of training data among a plurality of training data is considered. Therefore, the projection matrix W optimized to widen the interclass distance of such critical portions can be calculated even in the case where data are distributed such that only a part of the classes overlaps, unlike LDA which focuses on only the average.

However, in WLDA, there are cases where a pair of two classes giving a minimum value of interclass dispersion of a numerator of an objective function such as the expression (15) and a class giving a minimum value of intraclass dispersion of a denominator of that are different classes. In such a case, the class giving the minimum value of the intraclass dispersion of the denominator may not related to the critical portions, and the optimization may be insufficient.

Therefore, in WRLDA, which is an example of the projection matrix calculation processing of this example embodiment, the objective function of the optimization problem of the expression (15) is modified from that of the WLDA. Hereinafter, WRLDA, which is an example of the projection matrix calculation processing of this example embodiment, will be described. The optimization problem in WRLDA is as shown in the following expressions (17) to (19). Note that ni and nn in the expression (18) represent the number of data of the class indices i and j, respectively.

$$\begin{matrix}[ Math . 17 ] & \\ {arg max}_{Σ} \{ {min}_{i , j} \frac{tr ( {S}_{ij} Σ )}{tr ( {\overline{S}}_{i , j} Σ )} \} & ( 17 )\end{matrix}$$

$$\begin{matrix}[ Math . 18 ] & \\ {\overline{S}}_{i , j} = \frac{{n}_{i} {S}_{i} + {n}_{j} {S}_{j}}{{n}_{i} + {n}_{j}} & ( 18 )\end{matrix}$$

$$\begin{matrix}[ Math . 19 ] & \\ s . t . Σ ∈ {ℳ}_{e} & ( 19 )\end{matrix}$$

The matrix Sᵢⱼ included in the objective function of WRLDA is a matrix (first term) indicating an interclass variance between the i-th class (first class) and the j-th class (second class). The matrix S_{i,j} (overline omitted) is a matrix (second term) indicating a weighted average of intraclass variances in two classes used for calculating the interclass variance. A function including a first term indicating interclass dispersion between the first class and the second class, which is a numerator of a fraction of the expression (17), is a first function, and a function including a second term indicating intraclass dispersion in at least one of the first class and the second class, which is a denominator of the fraction of the expression (17), is a second function. In WRLDA, roughly, the projection matrix W is determined so as to maximize a minimum value of a ratio of the first function to the second function over a plurality of classes.

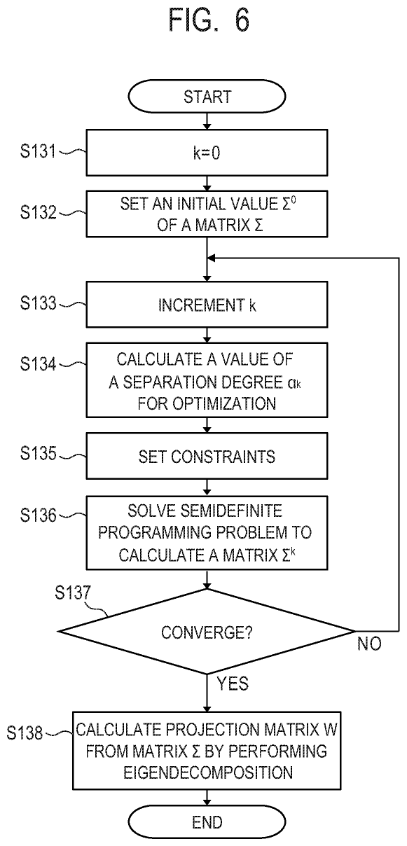

The effect of WRLDA will be described in detail with reference to FIG. 5. FIG. 5 is a diagram schematically showing a relationship between variances of a plurality of classes and directions of projection axes. FIG. 5 schematically shows a distribution of training data classified into a plurality of classes. In the example of FIG. 5, it is assumed that the training data is two-dimensional for simplicity of illustration, and the projection matrix for reducing the dimension of two-dimensional data to one-dimensional is calculated. The first axis and the second axis of FIG. 5 correspond to two dimensions of training data. The oval broken lines indicate intraclass variances of classes CL, CL2, and CL3. Roughly, it can be considered that training data of the corresponding classes are distributed in the regions in the broken lines of the classes CL1, CL2, and CL3. The rectangular dots arranged in the broken lines of the classes CL1, CL2, and CL3 represent the intraclass average of each class.

In the example of FIG. 5, it is assumed that a part of the distributions of the class CL1 and the class CL2 overlaps. Here, it is assumed that the class CL3 is sufficiently separated from both the class CL1 and the class CL2. A region R in FIG. 5 indicates an overlapped portion between the class CL1 and the class CL2. The calculation of the optimal projection matrix in this example embodiment corresponds to determining the direction of the projection axis that most effectively separates the classes CL1 and CL2 in the two-dimensional data of FIG. 5.

An arrow A1 indicates a direction of the projection axis which can be calculated in the case where WLDA is used. As can be understood from FIG. 5, the direction of the arrow A1 is slightly different from a direction that minimizes the influence of the region R, that is, the direction of the minimum width of the region R. This is because the intraclass variance of class CL3 is very large. Since the direction in which the influence of the intraclass variance of the class CL3 is minimized is the minor axis direction of the ellipse of the class CL3 in FIG. 5, the direction of the arrow A1 is also close to the minor axis direction of the ellipse of the class CL3. In this case, the projection axis does not minimize the influence of the overlapped portion between the class CL1 and the class CL2.

An arrow A2 indicates a direction of the projection axis which can be calculated in the case where the projection matrix calculation processing of WRLDA is used. As can be understood from FIG. 5, the direction of the arrow A2 is close to a direction that minimizes the influence of the region R, that is, the direction of the minimum width of the region R. In the expression (17) of WRLDA, the intraclass variance is calculated from the same class as the class used for calculating the interclass variance. Therefore, in the example of FIG. 5, since the direction of the projection axis is optimized without being affected by the intraclass variance of the class CL3, the direction of the projection axis is determined so as to minimize the influence of the region R.

As described above, in WRLDA, the intraclass variance is calculated by the same class as the class used for calculating the interclass variance. By using a ratio of these for the objective function, a critical portion where a plurality of classes overlaps is emphasized. Thus, according to WRLDA, there is provided the information processing apparatus 1 which realizes dimensionality reduction in which classes can be well separated.

### Second Example Embodiment

Hereinafter, a second example embodiment will be described. This example embodiment is an example of the projection matrix calculation processing in the WRLDA described in the first example embodiment.

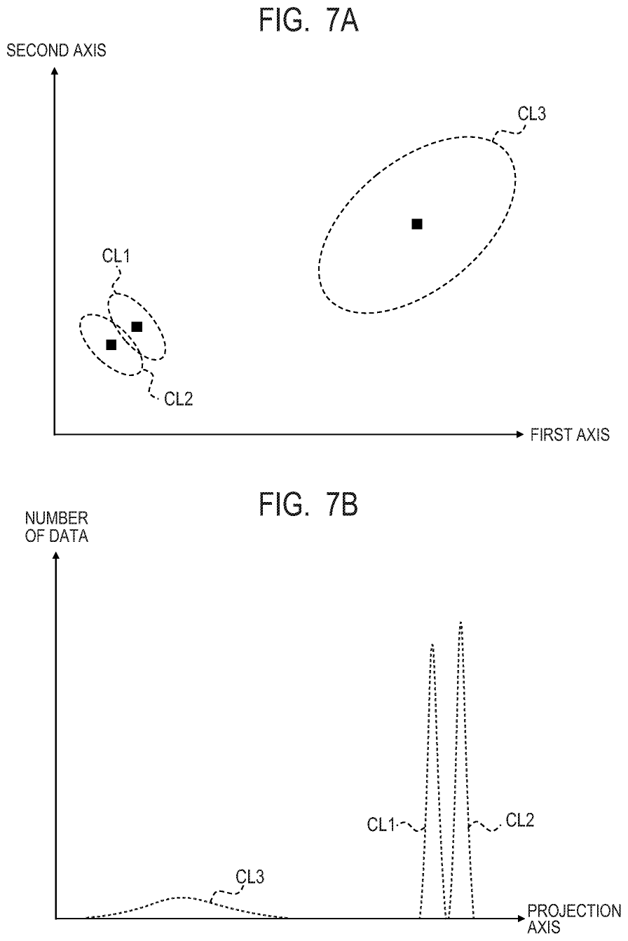

The details of the projection matrix calculation processing in the step S13 of FIG. 3 will be described with reference to FIG. 6. FIG. 6 is a flowchart showing an outline of projection matrix calculation processing performed by the information processing apparatus 1 according to this example embodiment.

In step S131, the projection matrix calculation unit 110 sets the value of k to 0. Here, k is a loop counter variable in the loop processing of the optimization of the matrix Σ. In step S132, the separation degree calculation unit 111 appropriately sets an initial value Σ⁰ corresponding to k=0 of the matrix Σ.

The following steps S133 to S137 are loop processing for optimizing the matrix Σ. In the following description, an index k may be added to variables corresponding to the value k of the loop counter, that is, variables in the k-th iteration. In the step S133, the projection matrix calculation unit 110 increments the value of k. Note that, “increment” is arithmetic processing for increasing the value of k by 1.

In the step S134, the separation degree calculation unit 111 calculates a value of a separation degree αₖ of optimization. The separation degree αₖ is determined by the following expression (20) based on the expression (17) and the matrix Σ^{k-1} obtained by the (k−1)-th iteration. Although proof is omitted, since the separation degree αₖ is non-decreasing with respect to the increase in k and is bounded from above, it is understood that this optimization algorithm converges.

$$\begin{matrix}[ Math . 20 ] & \\ {α}_{k} = {min}_{i , j} \frac{tr ( {S}_{ij} {Σ}^{k - 1} )}{tr ( {\overline{S}}_{i , j} {Σ}^{k - 1} )} & ( 20 )\end{matrix}$$

The problem of obtaining the matrix Σ^{k} in the k-th iteration is reduced to the semidefinite programming problem of the following expressions (21) to (23). The expression (21) is an objective of the semidefinite programming problem, and the expressions (22) and (23) are constraints of the semidefinite programming problem. In addition, t in the expressions (21) and (22) is an auxiliary variable.

$$\begin{matrix}[ Math . 21 ] & \\ {arg min}_{Σ , t} - t & ( 21 )\end{matrix}$$

$$\begin{matrix}[ Math . 22 ] & \\ tr [ \{ {S}_{ij} - {α}_{k} {\overline{S}}_{i , j} \} Σ ] \geq t \geq 0 , ∀ i , j & ( 22 )\end{matrix}$$

$$\begin{matrix}[ Math . 23 ] & \\ tr ( Σ ) = r , {0}_{d} ≼ Σ ≼ {I}_{d} & ( 23 )\end{matrix}$$

In the step S135, the constraint setting unit 112 calculates the above-described expressions (22) and (23) based on the training data and the matrix Σ^{k-1} in the previous iteration, and sets constraints for the semidefinite programming problem.

In the step S136, the projection matrix updating unit 113 solves the semidefinite programming problem of the expressions (21) to (23) described above, and calculates a matrix Σ^{k} in the k-th iteration. Since the semidefinite programming problem of the expressions (21) to (23) is a convex optimization problem that is relatively easy to solve, it can be solved using existing solvers.

In the step S137, the projection matrix updating unit 113 determines whether or not the matrix Σ converges in the k-th iteration. This determination can be made, for example, based on whether or not the following expression (24) is satisfied. Note that ε in the expression (24) is a determination threshold value, and in the case where the expression (24) is satisfied for a sufficiently small ε that is set in advance, it is determined that the matrix Σ converges.

[Math. 24]

|Σ^{k}−Σ^{k-1}|<ε (24)

In the case where it is determined that the matrix Σ^{k} converges (YES in the step S137), the processing proceeds to step S138, and the optimization is terminated by setting the matrix Σ^{k} at that time as the matrix Σ after the optimization. In the case where it is determined that the matrix Σ^{k} does not converge (NO in the step S137), the processing proceeds to the step S133, and the optimization is continued.

In step S138, the projection matrix updating unit 113 calculates the projection matrix W by performing eigendecomposition on the optimized matrix Σ. A specific method thereof will be described. First, d eigenvalues and eigenvectors corresponding to them are calculated from the matrix Σ of d rows and d columns. When D is a diagonal matrix in which the calculated d eigenvalues are the diagonal components, and V is an orthogonal matrix in which the calculated d eigenvectors (column vectors) are arranged in respective columns is V, this eigendecomposition can be expressed by the following expression (25).

[Math. 25]

Σ=VDV^{T} (25)

By generating a matrix in which r columns are selected from the orthogonal matrix V calculated in this manner based on the magnitude of the eigenvalues, it is possible to calculate the projection matrix W of d rows and r columns. The calculated projection matrix W is stored in the projection matrix storage unit 142.

As described above, according to the flowchart shown in FIG. 6, the matrix Σ is calculated by solving the optimization problem of the expressions (17) to (19), and the projection matrix W is calculated by performing eigendecomposition of the matrix Σ. Thus, an optimal projection matrix W, which is a solution of the expressions (17) to (19), can be obtained.

### Third Example Embodiment

Hereinafter, a third example embodiment will be described. This example embodiment is a modified example of the WRLDA described in the first example embodiment and the second example embodiment.

In this example embodiment, PWRLDA, which is another example of projection matrix calculation processing, will be described. In the PWRLDA, the objective function of the optimization problem of the expression (15) and the constraint in the optimization are modified from those of the WLDA described above. The optimization problem in the projection matrix calculation processing of PWRLDA is as shown in the following expressions (26) and (27). Here, the matrix Sᵢⱼ and the matrix Σ are the same as those used in the above described expression (17). The matrix S_{i,j} (overline omitted) is the same as defined by the above described expression (18).

$$\begin{matrix}[ Math . 26 ] & \\ {arg max}_{{Σ}_{i}} \{ {min}_{j} \frac{tr ( {S}_{ij} {Σ}_{i} )}{tr ( {\overline{S}}_{i , j} {Σ}_{i} )} \} ( i \neq j ) & ( 26 )\end{matrix}$$

$$\begin{matrix}[ Math . 27 ] & \\ s . t . {Σ}_{i} ∈ {ℳ}_{e} & ( 27 )\end{matrix}$$

In the expression (26) of PWRLDA, the difference from the expression (17) of WRLDA is that the fraction indicating the ratio of the first function including the first term indicating interclass dispersion and the second function including the second term indicating intraclass dispersion is minimized for only the coefficient j (i≠j). That is, under the constraint that the predetermined specific class is fixed as the i-th class, the fixed i-th class and an arbitrary j-th class other than the i-th class are selected, and interclass dispersion and intraclass dispersion are calculated between them, optimization is performed on the positive semidefinite matrix Σᵢ corresponding to the i-th class specified in advance. In other words, combinations of classes that do not include a specific class are excluded from the object of optimization.

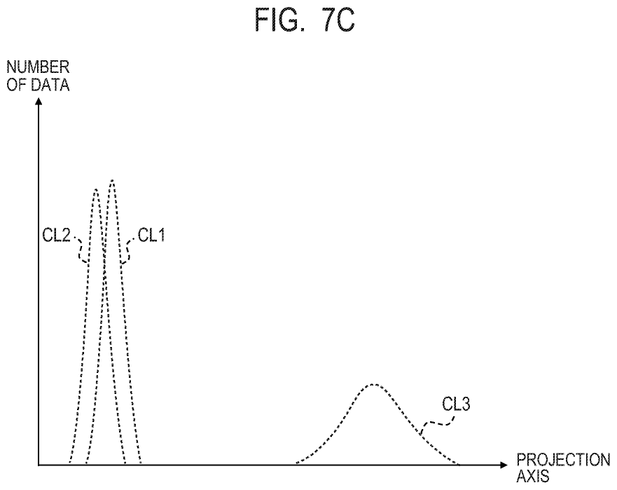

The effect of the PWRLDA will be described in detail with reference to FIGS. 7A to 7C. FIG. 7A schematically shows dispersion of a plurality of classes. FIG. 7A schematically shows a distribution of training data classified into a plurality of classes. FIG. 7A shows distribution of two-dimensional training data classified into three classes CL1, CL2, and CL3 as in FIG. 5.

FIG. 7B is a diagram showing a distribution of training data after projection in the case where the class CL1 is set as a specific class. In the example of FIG. 7B, by setting the class CL1 as a specific class, the condition of the separation degree between the class CL1 and the other classes is taken into consideration in the optimization, and therefore, the optimization is performed so as to improve the separation degree between classes including the class CL1. In the example of FIG. 7B, the condition of the separation degree between the class CL2 and the class CL3 is excluded from the constraint of the optimization. Therefore, as shown in FIG. 7B, in particular, the class CL1 and the class CL2 are well separated.

FIG. 7C is a diagram showing a distribution of the training data after projection in the case where the class CL3 is set as a specific class. In the example of FIG. 7C, by setting the class CL3 as a specific class, the condition of the separation degree between the class CL3 and the other classes is taken into consideration in the optimization, and therefore, the optimization is performed so as to improve the separation degree between classes including the class CL3. In the example of FIG. 7C, the condition of the separation degree between the class CL1 and the class CL2 is excluded from the constraint of the optimization. Therefore, as shown in FIG. 7C, since the separations between the class CL1 and the class CL2 are excluded from the constraints of the optimization, they are not separated. In particular, however, the class CL3 and the class CL1 are well separated from each other.

As described above, in the PWRLDA, the separation degree is optimized by a combination including a specific class. That is, the separation degree between classes other than the specific class is excluded from the constraint of the optimization. Therefore, the separation between the specific class and other classes can be made better than in the case of WRLDA. Thus, according to the PWRLDA, the information processing apparatus 1 is provided which realizes dimensionality reduction in which classes can be well separated.

For example, in the biometric matching using the biometric information, it is important to distinguish between the matching target person and another person, but it is not very important to distinguish between persons other than the matching target person. As described above, separation between a specific class and the other classes is required in class separation, but separation between classes other than the specific class is not very important in some cases. The PWRLDA is more effective in such cases because separation between the specific class and the other classes can be preferred.

As the projection matrix calculation processing in the PWRLDA, an algorithm substantially similar to that in the WRLDA shown in FIG. 6 except for the expressions used can be applied. In the PWRLDA, the above-described expressions (20) to (23) are substituted by the following expressions (28) to (31). The matrix in the k-th iteration corresponding to the i-th class specified in advance is Σᵢ^{k}. Other processing is the same as that of the WRLDA, and thus description thereof will be omitted.

$$\begin{matrix}[ Math . 28 ] & \\ {α}_{k} = {min}_{j} \frac{tr ( {S}_{ij} {Σ}_{i}^{k - 1} )}{tr ( {\overline{S}}_{i , j} {Σ}_{i}^{k - 1} )} & ( 28 )\end{matrix}$$

$$\begin{matrix}[ Math . 29 ] & \\ {arg min}_{{Σ}_{i} , t} - t & ( 29 )\end{matrix}$$

$$\begin{matrix}[ Math . 30 ] & \\ tr [ \{ {S}_{ij} - {α}_{k} {\overline{S}}_{i , j} \} {Σ}_{i} ] \geq t \geq 0 , i , ∀ j & ( 30 )\end{matrix}$$

$$\begin{matrix}[ Math . 31 ] & \\ tr ( {Σ}_{i} ) = r , {0}_{d} ≼ {Σ}_{i} ≼ {I}_{d} & ( 31 )\end{matrix}$$

Note that the optimization procedure or the method of calculating the projection matrix W from the matrix Σ is not limited thereto, and the algorithm may be appropriately modified as long as the projection matrix W can be obtained from the optimization problem of the expressions (17) to (19) or the expressions (26) and (27).

Note that “min” included in the objective function in the expression (17) can be appropriately changed according to the form of the objective function and is not limited thereto as long as it determines combinations of i and j based on some criteria. Further, “min” included in the objective function in the expression (26) can also be appropriately changed. However, since a combination of classes with the largest influence can be considered, it is desirable that the objective variable include “min” or “max”.

Further, “argmax” included in the expressions (17) and (26) can also be appropriately changed according to the form of the objective function and is not limited thereto as long as the objective function is optimized to obtain Σ based on some criteria. However, since the most suitable Σ can be obtained, it is desirable that the expressions (17) and (26) include “argmin” or “argmax”.

The matrix S_{i,j} (overline omitted) of the expression (18) is not limited to an average, and may be any matrix that uses at least one of the matrices Sᵢ and Sⱼ. However, since the two classes can be evenly considered, it is desirable that the matrix S_{i,j} (overline omitted) be a weighted average of the two classes as shown in the expression (18).

### Fourth Example Embodiment

Hereinafter, a fourth example embodiment will be described. Since this example embodiment is a modified example of the first to third example embodiments, description of elements similar to those of the first to third example embodiments may be omitted or simplified.

In this example embodiment, the objective function is modified so as to add regularization terms in the WRLDA and PWRLDA optimization problems shown in the expressions (17) to (19), (26) and (27) of the first and third example embodiments. The configuration of this example embodiment is the same as that of the first to third example embodiments except for the difference of the expressions accompanying this modification. That is, the hardware configuration, block diagrams, flowcharts, and the like of this example embodiment are substantially the same as those of the first to third example embodiments shown in FIGS. 1 to 4 and 6. Therefore, in this example embodiment, a description of the same portions as those in the first to third example embodiments will be omitted.

First, an example in which the regularization terms of this example embodiment is applied to the WRLDA will be described. The WRLDA optimization problem in the projection matrix calculation processing of this example embodiment is as shown in the following expressions (32) and (33). Here, the matrix Sᵢⱼ and the matrix Σ are the same as those used in the above expression (17). The matrices S_{b} and S_{w} are the same as those defined by the above expressions (3) to (6). The matrix S_{i,j} (overline omitted) is the same as defined by the above expression (18). The coefficient β is a positive real number.

$$\begin{matrix}[ Math . 32 ] & \\ {arg max}_{Σ} [ {min}_{i , j} \frac{tr \{ ( {S}_{ij} + β {S}_{b} ) Σ \}}{tr \{ ( {\overline{S}}_{i , j} + β {S}_{w} ) Σ \}} ] & ( 32 )\end{matrix}$$

$$\begin{matrix}[ Math . 33 ] & \\ s . t . Σ ∈ {ℳ}_{e} & ( 33 )\end{matrix}$$

The WRLDA optimization problem of this example embodiment is different from the WRLDA optimization problem of the first example embodiment in that the aforementioned regularization terms βS_{b} and βS_{w} are added. βS_{b} is a regularization term (third term) indicating an average of interclass dispersion in the LDA, and βS_{w} is a regularization term (fourth term) indicating an average of intraclass dispersion in the LDA. That is, in this example embodiment, the objective function of the WRLDA of the first example embodiment and the objective function of the LDA are compatible with each other by weighted addition at a ratio corresponding to the coefficient β.

In the WRLDA of the first example embodiment, in order to emphasize critical portions where a plurality of classes overlaps, optimization is performed focusing on combinations of worst-case classes. In such an optimization method, in the case where there is an outlier in the training data, the optimization may be performed depending extremely on the outlier. In the WRLDA of this example embodiment, since the regularization terms indicating the average of the interclass variance and the average of the intraclass variance in the LDA are introduced, not only the worst case but also the average is considered to some extent. Therefore, in the WRLDA of this example embodiment, in addition to the effect similar to that of the WRLDA of the first example embodiment, by introducing the regularization terms based on the LDA, the effect of improving the robustness for the outliers that can be included in the training data may be obtained.

Next, details of the WRLDA projection matrix calculation processing of this example embodiment will be described. Although the flowchart of the processing itself is the same as that of FIG. 6, the expressions used in some steps are changed because the expressions of the optimization problem are different. Therefore, in this example embodiment, with reference to the flowchart of FIG. 6 again, only steps in which processing is performed according to expressions different from that of the second example embodiment will be extracted and described.

Since the processing in the steps S131 to S133 is similar to that in the second example embodiment, the description thereof will be omitted. In step S134, the separation degree calculation unit 111 calculates the value of the separation degree αₖ of the optimization. The separation degree αₖ is determined by the following expression (34) based on the expression (32) and the matrix Σ^{k-1} obtained by the (k−1)-th iteration.

$$\begin{matrix}[ Math . 34 ] & \\ {α}_{k} = {min}_{i , j} \frac{tr \{ ( {S}_{ij} + β {S}_{b} ) {Σ}^{k - 1} \}}{tr \{ ( {\overline{S}}_{i , j} + β {S}_{w} ) {Σ}^{k - 1} \}} & ( 34 )\end{matrix}$$

The problem of obtaining the matrix Σ^{k} in the k-th iteration is reduced to the semidefinite programming problem of the following expressions (35) to (37). The expression (35) is an objective of the semidefinite programming problem, and the expressions (36) and (37) are constraints of the semidefinite programming problem. In addition, t in the expressions (35) and (36) is an auxiliary variable.

$$\begin{matrix}[ Math . 35 ] & \\ {arg min}_{Σ , t} - t & ( 35 )\end{matrix}$$

$$\begin{matrix}[ Math . 36 ] & \\ tr [ \{ ( {S}_{ij} + β {S}_{b} ) - {α}_{k} ( {\overline{S}}_{i , j} + β {S}_{w} ) \} Σ ] \geq t \geq 0 , ∀ i , j & ( 36 )\end{matrix}$$

$$\begin{matrix}[ Math . 37 ] & \\ tr ( Σ ) = r , {0}_{d} ≼ Σ ≼ {I}_{d} & ( 37 )\end{matrix}$$

Since the semidefinite programming problem of expressions (35) to (37) is a convex optimization problem as in the case of the second example embodiment, it can be solved in the same manner as in the second example embodiment. The processing of the steps S135 to step S138 is the same as that of the second example embodiment except that the expressions to be used are the expressions (35) to (37) described above, and thus description thereof is omitted. Therefore, the optimal projection matrix W can be calculated for the WRLDA optimization problem of this example embodiment as in the second example embodiment.

Next, an example in which the regularization terms of this example embodiment is applied to the PWRLDA will be described. The PWRLDA optimization problem in the projection matrix calculation processing of this example embodiment is as shown in the following expressions (38) and (39). Here, the matrix Sᵢⱼ and the matrix Σ are the same as in the above expressions (17). The matrices S_{b} and S_{w} are the same as those defined by the above expressions (3) to (6). The matrix S_{i,j} (overline omitted) is the same as defined by the above expression (18). The coefficient β is a positive real number.

$$\begin{matrix}[ Math . 38 ] & \\ {arg max}_{{Σ}_{i}} [ {min}_{j} \frac{tr \{ ( {S}_{ij} + β {S}_{b} ) {Σ}_{i} \}}{tr \{ ( {\overline{S}}_{i , j} + β {S}_{w} ) {Σ}_{i} \}} ] ( i \neq j ) & ( 38 )\end{matrix}$$

$$\begin{matrix}[ Math . 39 ] & \\ s . t . {Σ}_{i} ∈ {ℳ}_{e} & ( 39 )\end{matrix}$$

The PWRLDA optimization problem of this example embodiment is different from the PWRLDA optimization problem of the third example embodiment in that the aforementioned regularization terms βS_{b} and βS_{w} are added. βS_{b} is a regularization term (third term) indicating an average of interclass dispersion in the LDA, and βS_{w} is a regularization term (fourth term) indicating an average of intraclass dispersion in the LDA. In other words, in this example embodiment, the objective function of the PWRLDA of the third example embodiment and the objective function of the LDA are compatible with each other by weighted addition at a ratio corresponding to the coefficient β.

In the PWRLDA of this example embodiment, similarly to the example of WRLDA described above, since the regularization terms indicating the average of the interclass variance and the average of the intraclass variance in the LDA are introduced, not only the worst case but also the average are considered to some extent. Therefore, in the PWRLDA of this example embodiment, in addition to the effect similar to that of the PWRLDA of the third example embodiment, by introducing the regularization terms based on the LDA, the effect of improving the robustness for the outliers that can be included in the training data may be obtained.

As the projection matrix calculation processing in the PWRLDA, an algorithm substantially similar to that in the WRLDA of this example embodiment can be applied except for the expressions that are used. In the PWRLDA, the above-described expressions (34) to (37) are substituted by the following expressions (40) to (43). Other processing is the same as that of the WRLDA, and thus description thereof will be omitted.

$$\begin{matrix}[ Math . 40 ] & \\ {α}_{k} = {min}_{j} \frac{tr \{ ( {S}_{ij} + β {S}_{b} ) {Σ}_{i}^{k - 1} \}}{tr \{ ( {\overline{S}}_{i , j} + β {S}_{w} ) {Σ}_{i}^{k - 1} \}} ( i \neq j ) & ( 40 )\end{matrix}$$

$$\begin{matrix}[ Math . 41 ] & \\ {arg min}_{{Σ}_{i} , t} - t & ( 41 )\end{matrix}$$

$$\begin{matrix}[ Math . 42 ] & \\ tr [ \{ ( {S}_{ij} + β {S}_{b} ) - {α}_{k} ( {\overline{S}}_{i , j} + β {S}_{w} ) \} {Σ}_{i} ] \geq t \geq 0 , i , ∀ j ( i \neq j ) & ( 42 )\end{matrix}$$

### Fifth Example Embodiment

Hereinafter, a fifth example embodiment will be described. In the fifth example embodiment, as a modified example of the information processing apparatus 1 of the first to fourth example embodiments, an information processing system that transmits projection matrices to a plurality of user terminals is exemplified. Further, in this example embodiment, it is assumed that the processing used for calculating the projection matrix is the above-described PWRLDA.

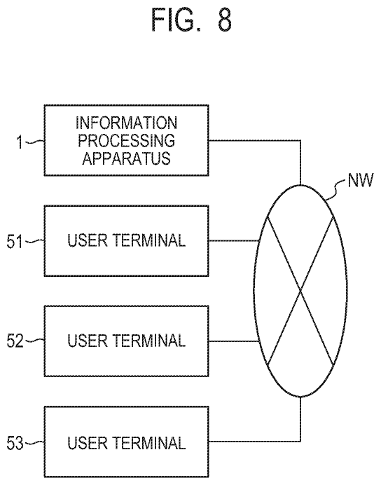

FIG. 8 is a block diagram showing a configuration of an information processing system according to this example embodiment. As shown in FIG. 8, the information processing system includes an information processing apparatus 1 and a plurality of user terminals 51, 52, and 53. The information processing apparatus 1 and the plurality of user terminals 51, 52, and 53 are communicably connected to each other via a network NW. Since the hardware configuration of the information processing apparatus 1 and the plurality of user terminals 51, 52, and 53 can be similar to that shown in FIG. 1, description thereof will be omitted. The number of the plurality of user terminals 51, 52, and 53 is three in FIG. 8, but this is an example and is not particularly limited thereto. Each of the user terminals 51, 52, and 53 is a terminal held by a different user. The user terminals 51, 52, and 53 have a feature selection function by performing dimensionality reduction using the projection matrix. A specific example of such a function is a dimensionality reduction of feature amount data for biometric authentication. That is, the user terminals 51, 52, and 53 may be biometric authentication devices.

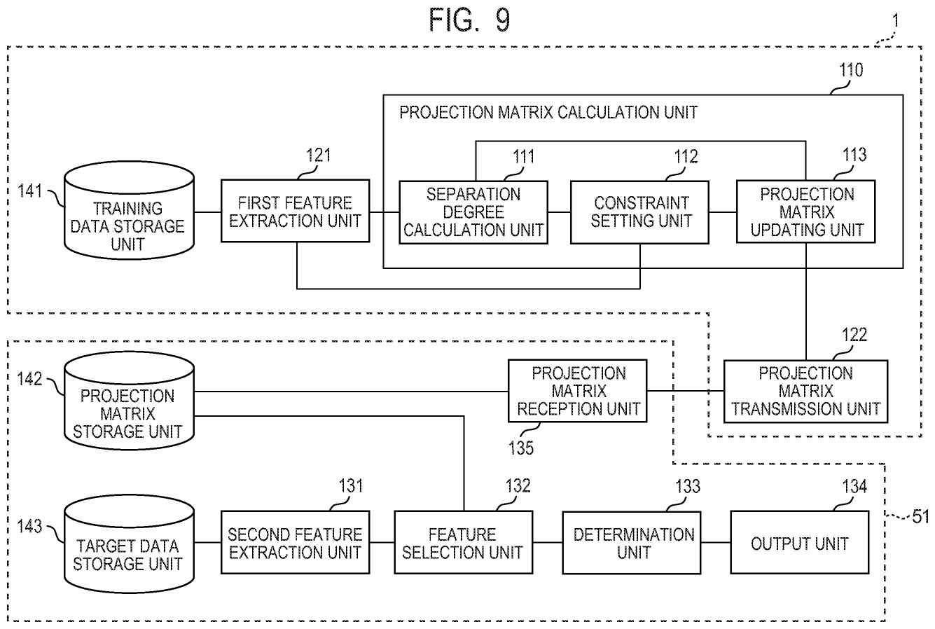

FIG. 9 is a functional block diagram showing a configuration of the information processing system according to this example embodiment. The information processing apparatus 1 includes a projection matrix calculation unit 110, a first feature extraction unit 121, a projection matrix transmission unit 122, and a training data storage unit 141. The user terminal 51 includes a second feature extraction unit 131, a feature selection unit 132, a determination unit 133, an output unit 134, a projection matrix reception unit 135, a projection matrix storage unit 142, and a target data storage unit 143. Although not shown, the user terminals 52 and 53 may have similar configuration as the user terminal 51. The functions of the projection matrix transmission unit 122 and the projection matrix reception unit 135 are realized by the processor 101 controlling the communication I/F 103 based on a program. The projection matrix transmission unit 122 may be referred to as a transmission means more generally.

As shown in FIG. 9, the projection matrix calculation unit 110 of the information processing apparatus 1 calculates a projection matrix based on the PWRLDA. The projection matrix transmission unit 122 of the information processing apparatus 1 has a function of transmitting the projection matrix to the user terminals 51, 52, and 53. The projection matrix reception unit 135 of each of the user terminals 51, 52, and 53 has a function of performing feature selection using the projection matrix received from the information processing apparatus 1. Since the functions of the other functional blocks are similar to those of the first to fourth example embodiments, their description is omitted.

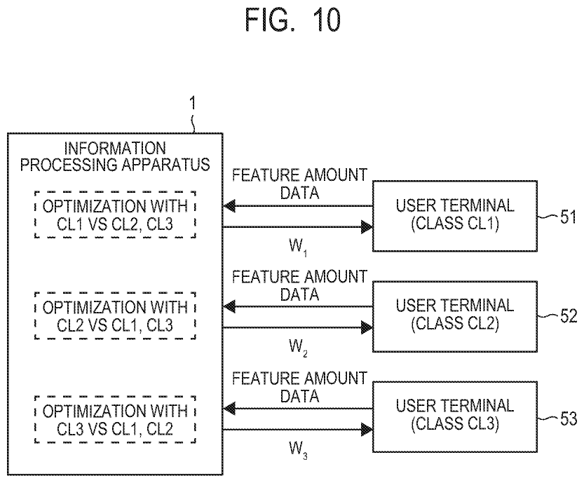

FIG. 10 is a schematic diagram showing an operation of the information processing system according to this example embodiment. As shown in FIG. 10, classes corresponding to the user terminals 51, 52, and 53 are defined as classes CL1, CL2, and CL3, respectively. The information processing apparatus 1 calculates a projection matrix W₁ based on the PWRLDA using the feature amount data acquired from the user terminal 51 of the class CL1. In this processing, a specific class in the PWRLDA is defined as the class CL1. That is, in this optimization, separation between the classes CL1 and CL2 and separation between the classes CL1 and CL3 are considered, but separation between the classes CL2 and CL3 is not considered. Thereby, the projection matrix W₁ is specialized for the feature separation between the class CL1 and the other classes. The information processing apparatus 1 transmits the projection matrix W₁ to the user terminal 51. Thereby, the user terminal 51 can perform the dimensionality reduction using the projection matrix W₁ specialized for the feature separation between the class CL1 which is the class of the user terminal 51 itself and the other classes.

Similarly, the information processing apparatus 1 transmits a projection matrix W₂ calculated using the class CL2 as the specific class in the PWRLDA to the user terminal 52, and transmits a projection matrix W₃ calculated using the class CL3 as the specific class in the PWRLDA to the user terminal 53. Thereby, the user terminals 52 and 53 can perform dimensionality reduction by using a projection matrix specialized for feature separation between their classes and other classes.

As described above, in this example embodiment, the projection matrices W₁, W₂, and W₃ are transmitted to the plurality of user terminals 51, 52, and 53 corresponding to the plurality of classes C1, CL2, and CL3, respectively. The projection matrices W₁, W₂, and W₃ are projection matrices calculated based on the PWRLDA using the classes of the corresponding user terminals 51, 52, and 53 as specific classes. This allows each user terminal to receive a projection matrix specialized for its class for feature separation between the specific class and the other classes. Then, each user terminal can perform dimensionality reduction to suitably separate classes using the projection matrix.

The configuration of this example embodiment can be applied to any system that performs class separation, but can be suitably used, for example, for a user terminal having a biometric matching function of an owner. In such a user terminal, it is important to distinguish between the owner and a person other than the owner, but it is not very important to distinguish between persons other than the owner. The PWRLDA has the effect of suitably separating the specific class and other classes. Therefore, by setting the owner of the user terminal, that is, the matching target person in the biometric matching to the specific class of the PWRLDA, the performance of the class separation can be improved, and the matching accuracy can be improved.

In the first to fifth example embodiments, the type of data to be processed is not particularly limited. For example, the data to be processed is preferably feature amount data extracted from biometric information. In many cases, the feature amount data is multidimensional data, and processing may be difficult as it is. By performing the dimensionality reduction of the feature amount data by the processing of the first to fifth example embodiments, the determination using the feature amount data can be made more appropriate. In the following sixth example embodiment, a specific example of an apparatus which can apply a determination result by feature extraction using the projection matrix W calculated by the information processing apparatus 1 according to the first to fifth example embodiments will be described.

### Sixth Example Embodiment

Hereinafter, a sixth example embodiment will be described. In the sixth example embodiment, as an application example of the information processing apparatus 1 according to the first to fifth example embodiments, an information processing system that performs ear acoustic matching based on an acoustic characteristic acquired by an earphone is exemplified. The ear acoustic matching is a technology for comparing the acoustic characteristics of the head including an ear canal of a person to determine the identity of the person. Since the acoustic characteristics of the ear canal vary from person to person, they are suitable for biometric information used for personal matching. For this reason, the ear acoustic matching may be used for user identification of a hearable device such as an earphone. It should be noted that the ear acoustic matching is used not only for determining the identity of the person, but also for determining a wearing state of a hearable device.

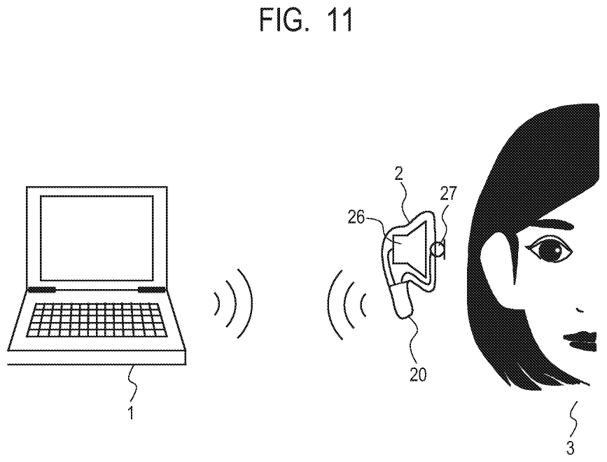

FIG. 11 is a schematic diagram showing an overall configuration of the information processing system according to this example embodiment. The information processing system includes an information processing apparatus 1 and an earphone 2 which can be wirelessly connected to each other.

The earphone 2 includes an earphone control device 20, a speaker 26, and a microphone 27. The earphone 2 is an audio device that can be worn on the head, in particular on the ear, of the user 3, and is typically a wireless earphone, a wireless headset, or the like. The speaker 26 functions as a sound wave generation unit that generates sound waves toward the ear canal of the user 3 when worn, and is arranged on the wearing surface side of the earphone 2. The microphone 27 is arranged on the wearing surface side of the earphone 2 so as to receive sound waves echoed in the ear canal or the like of the user 3 when worn. The earphone control device 20 controls the speaker 26 and the microphone 27 and communicates with the information processing apparatus 1.

In this specification, “sound” such as sound waves and voice include a non-audible sound whose frequency or sound pressure level is out of the audible range.

The information processing apparatus 1 is an apparatus similar to that described in the first to fifth example embodiments. The information processing apparatus 1 is, for example, a computer communicably connected to the earphone 2, and performs biometric matching based on audio information. The information processing apparatus 1 further controls the operation of the earphone 2, transmits audio data for generating sound waves emitted from the earphone 2, and receives audio data obtained from sound waves received by the earphone 2. As a specific example, in the case where the user 3 listens to music using the earphone 2, the information processing apparatus 1 transmits compressed music data to the earphone 2. In the case where the earphone 2 is a telephone apparatus for a business instruction in an event venue, a hospital, or the like, the information processing apparatus 1 transmits audio data of the business instruction to the earphone 2. In this case, the audio data of the speech of the user 3 may be transmitted from the earphone 2 to the information processing apparatus 1.

This overall configuration merely an example, and for example, the information processing apparatus 1 and the earphone 2 may be connected by wire. In addition, the information processing apparatus 1 and the earphone 2 may be configured as an integrated apparatus, and another apparatus may be included in the information processing system.

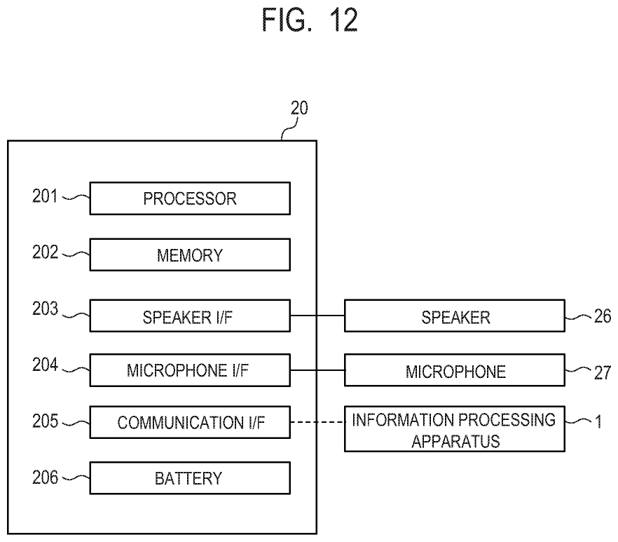

FIG. 12 is a block diagram showing a hardware configuration example of the earphone control device 20. The earphone control device 20 includes a processor 201, a memory 202, a speaker I/F 203, a microphone I/F 204, a communication I/F 205, and a battery 206. The components of the earphone control device 20 are connected to each other via a bus, wiring, a driving device, and the like (not shown).

Description of the processor 201, the memory 202, and the communication I/F 205 is omitted because it overlaps with the first example embodiment.

The speaker I/F 203 is an interface for driving the speaker 26. The speaker I/F 203 includes a digital-to-analog conversion circuit, an amplifier, and the like. The speaker I/F 203 converts audio data into an analog signal and supplies the analog signal to the speaker 26. Thereby, the speaker 26 emits a sound wave based on the sound data.

The microphone I/F 204 is an interface for acquiring a signal from the microphone 27. The microphone I/F 204 includes an analog-to-digital conversion circuit, an amplifier, and the like. The microphone I/F 204 converts an analog signal generated by the sound wave received by the microphone 27 into a digital signal. Thus, the earphone control device 20 acquires sound data based on the received sound wave.

The battery 206 is, for example, a secondary battery, and supplies power necessary for the operation of the earphone 2. Thus, the earphone 2 can operate wirelessly without being connected by wire to an external power source. When the earphone 2 is wired, the battery 206 may not be provided.

It should be noted that the hardware configuration shown in FIG. 12 is an example, and other devices may be added, or some devices may not be provided. Some devices may be replaced with other devices having similar functions. For example, the earphone 2 may further include an input device such as a button so as to accept an operation by the user 3, and may further include a display device such as a display or an indicator lamp for providing information to the user 3. Thus, the hardware configuration shown in FIG. 8 can be changed as appropriate.

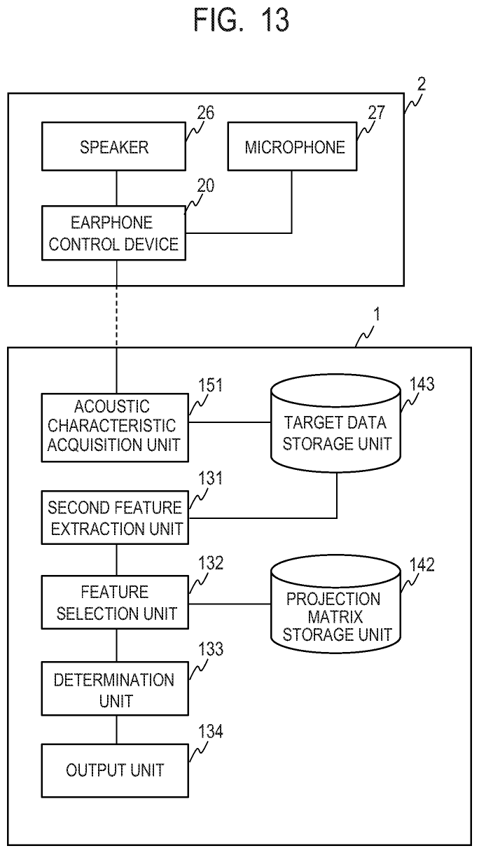

FIG. 13 is a functional block diagram of the earphone 2 and the information processing apparatus 1 according to this example embodiment. The information processing apparatus 1 includes an acoustic characteristic acquisition unit 151, a second feature extraction unit 131, a feature selection unit 132, a determination unit 133, an output unit 134, a target data storage unit 143, and a projection matrix storage unit 142. Since the configuration of the block diagram of the earphone 2 is the same as that of FIG. 7, the description thereof will be omitted. Among the functional blocks of the information processing apparatus 1, the functions of the components other than the acoustic characteristic acquisition unit 151 are the same as those described in the first example embodiment. It is assumed that the previously trained projection matrix W is stored in the projection matrix storage unit 142, and the illustration of the training functional blocks is omitted in FIG. 9. Specific contents of the processing performed by each functional block will be described later.

In FIG. 13, some or all of the functions of the functional blocks described in the information processing apparatus 1 may be provided in the earphone control device 20 instead of the information processing apparatus 1. That is, the functions described above may be implemented by the information processing apparatus 1, may be implemented by the earphone control device 20, or may be implemented by cooperation of the information processing apparatus 1 and the earphone control device 20. In the following description, it is assumed that the functional blocks related to the acquisition and determination of the acoustic information are provided in the information processing apparatus 1 as shown in FIG. 9, unless otherwise specified.

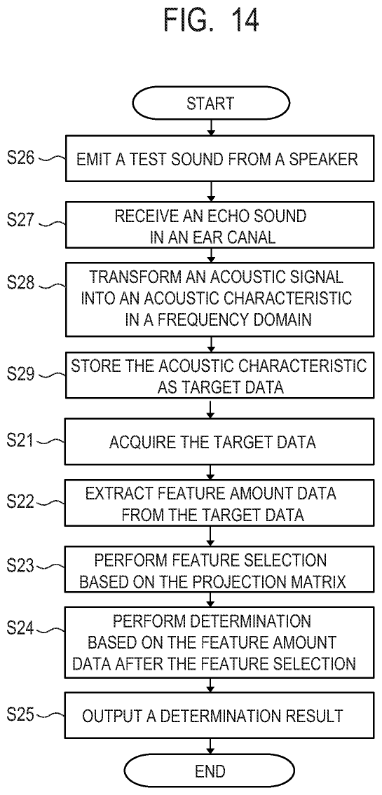

FIG. 14 is a flowchart showing an outline of biometric matching processing performed by the information processing apparatus 1 according to this example embodiment. The operation of the information processing apparatus 1 will be described with reference to FIG. 14.

The biometric matching process of FIG. 14 is executed, for example, in the case where the user 3 starts using the earphone 2 by operating it. Alternatively, the biometric matching processing of FIG. 14 may be executed every time a predetermined time elapses in the case where the power of the earphone 2 is turned on.

In step S26, the acoustic characteristic acquisition unit 151 instructs the earphone control device 20 to emit a test sound. The earphone control device 20 transmits a test signal to the speaker 26 and the speaker 26 emits a test sound generated based on the test signal to the ear canal of the user 3.

As the test signal, a signal including a frequency component in a predetermined range such as a chirp signal, a maximum length sequence (M-sequence) signal, white noise, an impulse signal, or the like can be used. Thereby, an acoustic signal including information within a predetermined frequency range can be acquired. The test sound may be an audible sound whose frequency and sound pressure level are within the audible range. In this case, by causing the user 3 to perceive the sound wave at the time of matching, it is possible to notify the user 3 that the matching is being performed. The test sound may be a non-audible sound whose frequency or sound pressure level is outside the audible range. In this case, the sound wave can be hardly perceived by the user 3, and the comfort at the time of use is improved.

In step S27, the microphone 27 receives an echo sound (ear sound) in the ear canal or the like and converts the echo sound into an electrical signal in the time domain. This electrical signal may be referred to as an acoustic signal. The microphone 27 transmits the acoustic signal to the earphone control device 20, and the earphone control device 20 transmits the acoustic signal to the information processing apparatus 1.

In step S28, the acoustic characteristic acquisition unit 151 obtains the acoustic characteristic in the frequency domain based on the sound wave propagating through the head of the user. The acoustic characteristic may be, for example, a frequency spectrum obtained by transforming an acoustic signal in the time domain into a frequency domain using an algorithm such as a fast Fourier transform.

In step S29, the target data storage unit 143 stores the acquired acoustic characteristics as target data for feature amount extraction.

Since the processing in the steps S21 to S25 is the same as that in FIG. 4, redundant description thereof will be omitted. In the case of ear acoustic matching, the processing of each step can be embodied as follows, but this example embodiment is not limited thereto.

The process of extracting the feature amount data from the target data in the step S22 may be, for example, a processing of extracting a logarithmic spectrum, a mel-cepstral coefficient, a linear prediction analysis coefficient, or the like from the acoustic characteristic. The feature selection processing in the step S23 may be a processing of reducing dimensions by applying a projection matrix to the multidimensional vector which is the feature amount data extracted in the step S22. The determination processing in the step S24 may be a process of determining whether or not the feature amount data corresponding to the user 3 matches any one of the feature amount data of one or more registrants registered in advance. The determination result output in the step S25 is used, for example, for control of permission or non-permission of use of the earphone 2.

In this example embodiment, the example of the ear acoustic matching has been described, but this example embodiment can be similarly applied to the biometric matching using other biometric information. Examples of biometric information that can be applied include a face, iris, fingerprint, palm print, vein, voice, auricle, and gait.

According to this example embodiment, by using the projection matrix obtained by the configurations of the first to fifth example embodiments, it is possible to provide the information processing apparatus 1 capable of suitably preforming the dimensionality reduction of the feature amount data extracted from the biometric information.

The apparatus or system described in the above example embodiments can also be configured as in the following seventh example embodiment.

### Seventh Example Embodiment

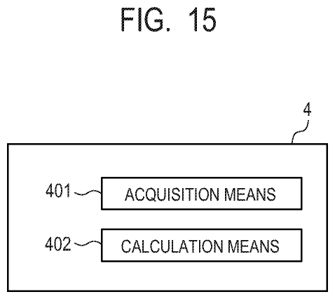

FIG. 15 is a functional block diagram of the information processing apparatus 4 according to the seventh example embodiment. The information processing apparatus 4 includes an acquisition means 401 and a calculation means 402. The acquisition means 401 acquires a plurality of data each classified into one of a plurality of classes. The calculation means 402 calculates a projection matrix used for dimensionality reduction of the plurality of data based on an objective function including a statistic of the plurality of data. The objective function includes a first function including a first term indicating interclass dispersion of the plurality of data between a first class and a second class included in the plurality of classes and a second function including a second term indicating intraclass dispersion of the plurality of data in at least one of the first class and the second class. The calculation means 402 performs calculation of the projection matrix by optimizing the objective function under a constraint in which the first class and the second class are selected so that a combination of the first class and the second class includes a specific class that is one of the plurality of classes.

According to this example embodiment, there is provided the information processing apparatus 4 which realizes dimensionality reduction in which classes can be better separated.

### Modified Example Embodiments

This disclosure is not limited to the above-described example embodiments, and can be appropriately modified without departing from the gist of this disclosure. For example, examples in which some of the configurations of any of the example embodiments are added to other example embodiments or examples in which some of the configurations of any of the example embodiments are replaced with some of the configurations of other example embodiments are example embodiments of this disclosure.

In the above-described example embodiments, the variance is used as an index of intraclass dispersion or interclass dispersion as an example, but any statistic other than variance may be used as long as it can serve as an index of dispersion.

A processing method in which a program for operating the configuration of the above-described example embodiment is stored in a storage medium so as to realize the functions of the above-described example embodiment, the program stored in the storage medium is read out as a code, and executed in a computer is also included in the scope of each example embodiment. That is, a computer-readable storage medium is also included in the scope of each example embodiment. In addition, not only the storage medium storing the above-described program but also the program itself are included in each example embodiment. Further, one or more components included in the above-described example embodiments may be a circuit such as an ASIC and an FPGA configured to realize the functions of the components.

Examples of the storage medium include a floppy disk, a hard disk, an optical disk, a magneto-optical disk, a compact disk (CD)-ROM, a magnetic tape, a non-volatile memory card, and a ROM. In addition, the scope of each example embodiment includes not only a system in which a program stored in the storage medium is executed by itself but also a system in which a program is executed by operating on an operating system (OS) in cooperation with other software and functions of an expansion board.

The service implemented by the functions of the above-described example embodiments can also be provided to the user in the form of software as a service (SaaS).

It should be noted that any of the above-described example embodiments is merely an example of an example embodiment for carrying out this disclosure, and the technical scope of this disclosure should not be interpreted as being limited by the example embodiments. That is, this disclosure can be implemented in various forms without departing from the technical idea or the main characteristics thereof

The whole or part of the example embodiments disclosed above can be described as, but not limited to, the following supplementary notes.

### Supplementary Note 1

An information processing apparatus comprising:
an acquisition means for acquiring a plurality of data each classified into one of a plurality of classes; and
a calculation means for calculating a projection matrix used for dimensionality reduction of the plurality of data based on an objective function including a statistic of the plurality of data,
wherein the objective function includes a first function including a first term indicating interclass dispersion of the plurality of data between a first class and a second class included in the plurality of classes and a second function including a second term indicating intraclass dispersion of the plurality of data in at least one of the first class and the second class, and
wherein the calculation means performs calculation of the projection matrix by optimizing the objective function under a constraint in which the first class and the second class are selected so that a combination of the first class and the second class includes a specific class that is one of the plurality of classes.

### Supplementary Note 2

The information processing apparatus according to supplementary note 1, wherein the objective function includes a minimum value or a maximum value of a ratio of the first function to the second function over the plurality of classes.

### Supplementary Note 3

The information processing apparatus according to supplementary note 1 or 2, wherein the second function includes a weighted average of intraclass dispersion of the plurality of data in the first class and intraclass dispersion of the plurality of data in the second class.

### Supplementary Note 4

The information processing apparatus according to any one of supplementary notes 1 to 3,
wherein the first function further includes a third term indicating an average of interclass dispersion of the plurality of data over the plurality of classes, and
wherein the second function further includes a fourth term indicating an average of intraclass dispersion of the plurality of data over the plurality of classes.

### Supplementary Note 5

The information processing apparatus according to any one of supplementary notes 1 to 4, wherein the optimization is a process of maximizing or minimizing the objective function.

### Supplementary Note 6

The information processing apparatus according to any one of supplementary notes 1 to 5, wherein the data are feature amount data extracted from biometric information.

### Supplementary Note 7

The information processing apparatus according to supplementary note 6, wherein the specific class is a class in which feature amount data corresponding to a matching target person in a biometric matching using the biometric information are classified.

### Supplementary Note 8

The information processing apparatus according to any one of supplementary notes 1 to 7,
wherein the plurality of classes corresponds to a plurality of terminals, respectively,
the information processing apparatus further including a transmission means for transmitting the projection matrix to a terminal corresponding to the specific class among the plurality of terminals.

### Supplementary Note 9

An information processing method performed by a computer, comprising:
acquiring a plurality of data each classified into one of a plurality of classes; and
calculating a projection matrix used for dimensionality reduction of the plurality of data based on an objective function including a statistic of the plurality of data,
wherein the objective function includes a first function including a first term indicating interclass dispersion of the plurality of data between a first class and a second class included in the plurality of classes and a second function including a second term indicating intraclass dispersion of the plurality of data in at least one of the first class and the second class, and
wherein the calculating the projection matrix includes performing calculation of the projection matrix by optimizing the objective function under a constraint in which the first class and the second class are selected so that a combination of the first class and the second class includes a specific class that is one of the plurality of classes.

### Supplementary Note 10

A storage medium storing a program that causes a computer to perform an information processing method, the information processing method comprising:
acquiring a plurality of data each classified into one of a plurality of classes; and
calculating a projection matrix used for dimensionality reduction of the plurality of data based on an objective function including a statistic of the plurality of data,
wherein the objective function includes a first function including a first term indicating interclass dispersion of the plurality of data between a first class and a second class included in the plurality of classes and a second function including a second term indicating intraclass dispersion of the plurality of data in at least one of the first class and the second class, and
wherein the calculating the projection matrix includes performing calculation of the projection matrix by optimizing the objective function under a constraint in which the first class and the second class are selected so that a combination of the first class and the second class includes a specific class that is one of the plurality of classes.

### Reference Signs List

1 and 4 information processing apparatus
2 earphone
3 user
20 earphone control device
26 speaker
27 microphone
51, 52, and 53 user terminal
101 and 201 processor
102 and 202 memory
103 and 205 communication I/F
104 input device
105 output device
110 projection matrix calculation unit
111 separation degree calculation unit
112 constraint setting unit
113 projection matrix updating unit
121 first feature extraction unit
122 projection matrix transmission unit
131 second feature extraction unit
132 feature selection unit
133 determination unit
134 output unit
135 projection matrix reception unit
141 training data storage unit
142 projection matrix storage unit
143 target data storage unit
151 acoustic characteristic acquisition unit
203 speaker I/F
204 microphone I/F
206 battery
401 acquisition means
402 calculation means

What is claimed is:

1. An information processing apparatus comprising:
a memory configured to store instructions; and
a processor configured to execute the instructions to:
acquire a plurality of data each classified into one of a plurality of classes; and
calculate a projection matrix used for dimensionality reduction of the plurality of data based on an objective function including a statistic of the plurality of data,
wherein the objective function includes a first function including a first term indicating interclass dispersion of the plurality of data between a first class and a second class included in the plurality of classes and a second function including a second term indicating intraclass dispersion of the plurality of data in at least one of the first class and the second class, and
wherein the projection matrix is calculated by optimizing the objective function under a constraint in which the first class and the second class are selected so that a combination of the first class and the second class includes a specific class that is one of the plurality of classes.

2. The information processing apparatus according to claim 1, wherein the objective function includes a minimum value or a maximum value of a ratio of the first function to the second function over the plurality of classes.

3. The information processing apparatus according to claim 1, wherein the second function includes a weighted average of intraclass dispersion of the plurality of data in the first class and intraclass dispersion of the plurality of data in the second class.

4. The information processing apparatus according to claim 1,
wherein the first function further includes a third term indicating an average of interclass dispersion of the plurality of data over the plurality of classes, and
wherein the second function further includes a fourth term indicating an average of intraclass dispersion of the plurality of data over the plurality of classes.

5. The information processing apparatus according to claim 1, wherein the optimization is a process of maximizing or minimizing the objective function.

6. The information processing apparatus according to claim 1, wherein the data are feature amount data extracted from biometric information.

7. The information processing apparatus according to claim 6, wherein the specific class is a class in which feature amount data corresponding to a matching target person in a biometric matching using the biometric information are classified.

8. The information processing apparatus according to claim 1,
wherein the plurality of classes corresponds to a plurality of terminals, respectively,
the processor is further configured to execute the instructions to transmit the projection matrix to a terminal corresponding to the specific class among the plurality of terminals.

9. An information processing method performed by a computer, comprising:
acquiring a plurality of data each classified into one of a plurality of classes; and
calculating a projection matrix used for dimensionality reduction of the plurality of data based on an objective function including a statistic of the plurality of data,
wherein the objective function includes a first function including a first term indicating interclass dispersion of the plurality of data between a first class and a second class included in the plurality of classes and a second function including a second term indicating intraclass dispersion of the plurality of data in at least one of the first class and the second class, and
wherein the calculating the projection matrix includes performing calculation of the projection matrix by optimizing the objective function under a constraint in which the first class and the second class are selected so that a combination of the first class and the second class includes a specific class that is one of the plurality of classes.

10. A non-transitory storage medium storing a program that causes a computer to perform an information processing method, the information processing method comprising:
acquiring a plurality of data each classified into one of a plurality of classes; and
calculating a projection matrix used for dimensionality reduction of the plurality of data based on an objective function including a statistic of the plurality of data,
wherein the objective function includes a first function including a first term indicating interclass dispersion of the plurality of data between a first class and a second class included in the plurality of classes and a second function including a second term indicating intraclass dispersion of the plurality of data in at least one of the first class and the second class, and
wherein the calculating the projection matrix includes performing calculation of the projection matrix by optimizing the objective function under a constraint in which the first class and the second class are selected so that a combination of the first class and the second class includes a specific class that is one of the plurality of classes.
